(19) United States
(12) Patent Application Publication
(10) Pub. No.: US 2024/0052161 A1
(43) Pub. Date: Feb. 15, 2024

(54) BIO-BASED POLYOLS FOR HIGH PERFORMANCE POLYURETHANE APPLICATIONS

(71) Applicants: INGEVITY UK LTD, Cheshire (GB); Lubrizol Advanced Materials, Inc., Cleveland, OH (US)

(72) Inventors: Scott D. Phillips, Cheshire (GB); Kurt Davidson, Cheshire (GB); Anthony Walder, Cleveland, OH (US)

(21) Appl. No.: 18/355,584

(22) Filed: Jul. 20, 2023

Related U.S. Application Data
(60) Provisional application No. 63/370,534, filed on Aug. 5, 2022.

(51) Int. Cl. C08L 75/06; C08G 18/12; C08G 18/42; C08G 18/32

(52) U.S. Cl. CPC C08L 75/06; C08G 18/12; C08G 18/4277; C08G 18/3206; C08L 2207/04

(57) ABSTRACT

Compositions and methods are described for polyurethanes with mechanical properties rivalling that of the highest performing commercially available elastomer materials by employing copolymers of a poly(farnesene) diol and ε-caprolactone as the polyol component. Poly(farnesene) diols are produced from biobased monomers and such copolymerization allows incorporation of renewable material in high performance polyurethane materials.

### CROSS-REFERENCE TO RELATED APPLICATIONS

The present disclosure claims priority to, and the benefit of, U.S. Provisional Application No. 63/370,534, filed 5 Aug. 2022 and titled BIO-BASED POLYOLS FOR HIGH PERFORMANCE POLYURETHANE APPLICATIONS, which is incorporated herein in its entirety for all purposes.

### BACKGROUND

1. Field of the Discovery. The present disclosure, in various embodiments, relates generally to bio-based polyols for preparation of high-performance polyurethane and associated applications.

2. Background Information. Polyurethane elastomers are versatile materials that are of extreme industrial importance due to the combination of good mechanical properties with ease and flexibility of processing. For example, polyurethane materials can be processed by conventional thermoplastic techniques, cast to give thermoset materials, blown to give microcellular foams, or dispersed in aqueous or organic media; all with just small adjustment to the formulation.

The ability to produce high performance polyurethanes from renewable resources, for example, to address the challenges of global warming and diminishing petroleum feedstocks, is a major limitation of the technology. Technical challenges in purification of bio-based feedstocks to give products of similar quality have hampered development, especially at a time when there is an accelerated demand for such materials. Few commercially available polyols based on renewable raw materials exist that give the same high-performance characteristics as petroleum-based products.

Another recognized limitation of polyurethane technology is the difficulty of producing soft materials (less than 75 Shore A), that can be produced efficiently and maintain their softness over time. The proportion of diisocyanate component in the formulation primarily dictates the hardness of the resulting polyurethane material. However, reducing the diisocyanate content (and thus elevating the polyol content) may give soft materials initially, but hardness builds over time due to the semi-crystalline nature of the polyols. Reducing the diisocyanate content also means there is less crystallinity to drive the solidification process in production and polyurethanes take longer to produce making process economically unviable.

Several methods have been disclosed with respect to preparing soft polyurethane materials. Canadian patent 1257946 claims the use of particular phthalate and phosphate plasticizers to give TPUs with a hardness of 60 to 80 Shore A. Plasticizers have the disadvantage of migrating from the part leading to cold hardening, fogging of surrounding surfaces, odor problems, etc. It is also a quite common problem that the plasticized product becomes sticky and unpleasing to touch with age. Many plasticizers, in particular phthalate-based ones, are in the process of being deregulated for environmental as well as health reasons.

In order to disrupt crystallinity and maintain softness without the use of plasticizers, prior work has focused on introducing random copolymers as the polyol component. US 2008/0139774 claims the use of branched polyester adipate diols in TPU formulations. It teaches that hardness can be maintained for up to 5 days at 23° C. (i.e., room temperature) and in the refrigerator. WO 2014/195211 has disclosed a TPU containing no plasticizers having a hardness of 30 to 55 Shore based on a linear polyester polyol derived from an aliphatic dicarboxylic acid and an aliphatic diol. However, in accordance with standard testing regime applied in WO 2014/195211, the results of very soft TPU formulations only indicates properties with a very short life span.

Polycaprolactone copolymerization technology has been used to address the challenge of cold hardening of polyurethanes materials as taught in WO 2020/099540. It has shown that materials can be kept soft for up to 6 months, both at room temperature and −4° C., by employing block copolymerization technology incorporating specific amounts of branching into the polycaprolactone copolymer. However, this technology requires the polyurethane processor to fine-tune their processes/formulation to allow commercially viable production times, and adoption of this technology is slow. This technology is also integrated into the petroleum supply chain; and therefore, poses environmental issues.

To this day, the raw material building blocks for polyurethane elastomers are overwhelmingly based on petroleum derived chemicals, particularly elastomers used in demanding applications where there cannot be compromise on mechanical properties or durability. Elastomers prepared from renewable sources struggle to achieve the high-performance characteristics of those based on traditional, petroleum based raw materials due to the technical challenges and expense involved in purification and controlled polymerization of such feedstocks.

Polyfarnesene diols (e.g. Krasol® F-3000, Total Cray Valley, Exton, Pennsylvania) have emerged as useful building blocks for polyurethane elastomers. These materials are derived from trans-beta farnesene, a biobased monomer produced by the fermentation of ligno-cellulosic sugars including xylose. The resulting polyol can be manufactured with narrow polydispersity and high purity. However, when used in elastomer formulations, articles produced lack mechanical strength and are of little commercial value in demanding polyurethane applications. They also have poor reactivity with common isocyanates such as MDI.

Despite high demand for plastic materials to be manufactured from renewable sources—reducing the global dependence on finite resources—there are few commercially available solutions based on bio-based raw materials that exhibit commercially acceptable processing times, mechanical properties and durability. Thus, there is a need for materials that overcome such challenges whilst maintaining a high bio-based content.

The availability of new bio-based polymer building blocks also helps overcome similar technical challenges in polyurethane adhesive, co-polyester, and polyamide technologies, in a more environmentally sustainable manner.

FR 2,384,810, describes polyether ester amides obtained by polymerization under autogenous pressure at temperatures between 230-300° C. The reaction mixture consists of one or more polyamide monomers, an alpha, omega-dihydroxy (polytetrahydrofuran) or PTMG of Mn (number averaged molecular weight) between 160-3000 g/mol, and at least one diacid in the presence of water. The water is then removed from the reaction medium which is brought back to normal or reduced pressure at a temperature between 250-280° C. The products obtained are block polymers and have good resistance to cold impact. However, the polymers obtained according to these patents have, for the same hardness, a lower melting temperature than those according to the invention.

U.S. Pat. No. 4,307,227 describes hot-melt type adhesives consisting of 50-80% of recurrence units derived from caprolactam and mixtures of dicarboxylic acids of primary amines and polyoxyalkylene glycol. The process used (reaction of all the constituents without catalyst between 220-250° C.) does not make it possible to synthesize products whose polyether sequences have an Mn greater than 1000 g/mol.

Patent applications J63-035622 and J63-277239 relate to polyether block amides obtained by reaction between an oligoamide of PA-6,6 containing one or more sequences of polyoxyalkylene dioxy and a polyoxyalkylene glycol or a diol of low mass under high vacuum at a temperature above 250° C. in the presence of an esterification catalyst, which is a metal tetraalkoxide. The use of low-mass polyoxyalkylene glycol or diol results in products having significantly lower melting points than those in the products of the present invention.

Patent application J63-182343 relates to polyether block amides obtained by reaction in the molten state of PA-6,6 sequences with diamine ends and of polyether with dicarboxylic chain ends. The polymers obtained according to this application have a high melting temperature; greater than 230° C., which requires high transformation temperatures, and therefore risks of degradation of the products during their transformation.

### SUMMARY

It has surprisingly and unexpectedly been discovered that polyurethanes with mechanical properties comparable to the highest performing commercially available elastomer materials can be obtained by employing copolymers of a diol and a lactone, e.g., a copolymer of a poly(farnesene) diol and ε-caprolactone, as the polyol component. Poly(farnesene) diols are produced from biobased monomers and such copolymerization allows incorporation of renewable material in high performance polyurethane materials.

The present disclosure provides polymer compositions and methods for producing copolymers of A-B-A type that is a reaction product of a diol and a cyclic lactone or cyclic ether. The described bio-based copolymers advantageously demonstrate at least one of commercially desirable processing times, mechanical properties, and/or durability.

Thus, in one aspect, the description provides a polymer and methods for producing copolymers of A-B-A type having an average molecular weight (Mn) of 1000 to 10,000 g/mol, said copolymer being the reaction product of a diol, e.g., poly(farnesene) diol, and a cyclic lactone or cyclic ether.

In any of the aspects or embodiments described herein, the poly(farnesene) diol is present in the range of about 10 to about 90 wt % of the total molecular weight of the block copolymer.

In any of the aspects or embodiments described herein, the cyclic lactone or cyclic ether is present in the range of about 10 to about 90 wt % of the total molecular weight of the block copolymer.

In an additional aspect, the description provides a polyurethane, polyurethane-urea, polyamide or co-polyester composition comprising a polymer as described herein.

In any aspect or embodiment described herein, a polyurethane or polyurethane urea composition comprises a block copolymer of A-B-A type, having an average molecular weight of 1000 to 10,000 g/mol, wherein the copolymer is the reaction product of a poly(farnesene) diol and a cyclic lactone or cyclic ether, a diisocyanate and a diol or diamine chain extender. In any aspect or embodiment described herein, the poly(farnesene) diol is present in the range of about 10 to about 90 wt % of the total molecular weight of the block copolymer. In any aspect or embodiment described herein, the cyclic lactone or cyclic ether is present in the range of about 10 to about 90 wt % of the total molecular weight of the block copolymer. In any aspect or embodiment described herein, the diol or diamine chain extender has a molecular weight of from about 60 to about 600 g/mol. In any aspect or embodiment described herein, the isocyanate to hydroxyl molar ratio (i.e., NCO:OH) is from about 0.9:1 to 2:1.

In any aspect or embodiment described herein, the copolymer as described herein ranges from about 25 to about 95 wt % of the polyurethane or polyurethane-urea.

In any aspect or embodiment described herein, the polyurethane or polyurethane urea comprises a Shore Hardness of between about 25 Shore A and about 60 Shore D.

The preceding general aspects and embodiments are given by way of example only and are not intended to be limiting on the scope of the present disclosure and appended claims. Additional objects and advantages associated with the compositions, methods, and processes of the present invention will be appreciated by one of ordinary skill in the art in light of the instant claims, description, and examples. For example, the various aspects and embodiments of the invention may be utilized in numerous combinations, all of which are expressly contemplated by the present description. These additional advantages objects and embodiments are expressly included within the scope of the present invention. The publications and other materials used herein to illuminate the background of the invention, and in particular cases, to provide additional details respecting the practice, are incorporated by reference.

### BRIEF DESCRIPTION OF DRAWINGS

The accompanying drawings, which are incorporated into and form a part of the specification, illustrate several embodiments of the present invention and, together with the description, serve to explain the principles of the invention. The drawings are only for the purpose of illustrating an embodiment of the invention and are not to be construed as limiting the invention. Further objects, features and advantages of the invention will become apparent from the following detailed description taken in conjunction with the accompanying figures showing illustrative embodiments of the invention, in which:

FIGS. 1A, 1B, and 1C illustrate the differences in mechanical properties of some exemplary polymer compositions as described herein. FIG. 1A shows a comparison, tensile strength (left-hand axis) and tear strength (right-hand axis) of the polymer compositions. FIG. 1B is a comparison of ultimate elongation of the polymer compositions. FIG. 1C is a comparison of the modulus of elasticity of the polymer compositions.

### DETAILED DESCRIPTION

It has surprisingly and unexpectedly been discovered that polyurethanes with mechanical properties comparable to the highest performing commercially available elastomer materials can be obtained by employing copolymers of a diol and a lactone or ether, e.g., a cyclic lactone, or cyclic ether as the polyol component. In addition, polyols as described herein can be used to produce polyurethane materials of less than 75 Shore A hardness that not only retains its hardness over time but can be produced with industrially viable cycle times.

Unless otherwise specified all terms have their ordinary meaning, accepted in the art of polymer technology.

Recitation of ranges of values are merely intended to serve as a shorthand method of referring individually to each separate value falling within the range, unless otherwise indicated, and each separate value is incorporated into the specification as if it were individually recited. Unless expressly indicated otherwise, the endpoints of all ranges are included within the range and independently combinable.

The articles “a” and “an” as used herein and in the appended claims are used herein to refer to one or to more than one (i.e., to at least one) of the grammatical object of the article unless the context clearly indicates otherwise. By way of example, “an element” means one element or more than one element.

The term “about,” means approximately. When the term “about” is used in conjunction with a numerical range, it modifies that range by extending the boundaries above and below the numerical values set forth. Illustratively, the use of the term “about” indicates that values slightly outside the cited values, i.e., plus or minus 0.1% to 10%, which are also effective and safe are included in the value. Numerical ranges recited herein by endpoints include all numbers and fractions subsumed within that range (e.g., 1 to 5 includes 1, 1.5, 2, 2.75, 3, 3.90, 4, and 5).

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.”

As used herein in the specification and in the claims, the phrase “at least one,” in reference to a list of one or more elements, should be understood to mean at least one element selected from anyone or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a nonlimiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

All method steps described in this disclosure can be performed in any order unless otherwise indicated or otherwise clearly contradicted by context. The use of any and all examples, or language indicating an example (e.g., “such as”), is intended merely for illustration and does not pose a limitation on the claimed scope unless explicitly claimed. No language in the specification should be construed as indicating any non-claimed element as essential to the practice of the embodiments of the claims.

As used herein, the phrase “less than” (e.g., less than about 2) or “less than or equal to” (e.g., less than or equal to about 2) followed by a number, means a non-zero number that is less than the stated number or a non-zero number that is less than or equal to the stated number, respectively.

In the claims, as well as in the specification above, all transitional phrases such as “comprises,” “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the 10 United States Patent Office Manual of Patent Examining Procedures, Section 2111.03.

As used in the specification and the appended claims, the terms “for example,” “for instance,” “such as,” “including” and the like are meant to introduce examples that further clarify more general subject matter. Unless otherwise specified, these examples are provided only as an aid for understanding the disclosure and are not meant to be limiting in any fashion.

Described herein are polyols or copolymers of a diol and a lactone or an either, e.g., a cyclic lactone or cyclic ether. The resulting polyols or copolymers are surprising and unexpectedly advantageous for the preparation of elastomers, e.g., polyurethane elastomers. As described above, polyurethanes with mechanical properties comparable to the highest performing commercially available elastomer materials can be obtained by employing copolymers as described herein as the polyol component.

In one aspect, the description provides a composition comprising a copolymer of a poly(farnesene) diol and a lactone or ether, e.g., a cyclic lactone or cyclic ether.

Farnesene exists in isomer forms, such as α-farnesene ((E,E)-3,7,11-trimethyl-1,3,6,10-dodecatetraene), and β-farnesene (7,11-dimethyl-3-methylene-1,6,10-dodecatriene), as well (E)-β-farnesene in which one or more hydrogen atoms have been replaced by another atom or group of atoms (i.e. substituted). In any aspect or embodiment described herein, the poly(farnesene) diol is formed by the polymerization of α-farnesene and/or β-farnesene monomers. In any of the aspects or embodiments described herein, the poly(farnesene) diol is formed by the polymerization of monomers selected from the group consisting of (E,E)-α-farnesene, (Z,E)-α-farnesene, (Z,Z)-α-farnesene, cis-β-farnesene, trans-β-farnesene, hydrogenated reactions products thereof, and combinations thereof. In any of the aspects or embodiments described herein, the the poly(farnesene) diol is formed by the polymerization of trans-β-farnesene.

The farnesene monomer used to produce embodiments of the poly(farnesene) diol as described herein may be prepared by chemical synthesis from petroleum resources, extracted from insects, such as Aphididae, or plants. Therefore, an advantage is that the polymer may be derived from a monomer obtained via a renewable resource. In certain aspects, it is prepared by culturing a microorganism using a carbon source derived from a saccharide. The farnesene resin may be efficiently prepared from farnesene monomer obtained via these sources.

In any of the aspects or embodiments described herein, the lactone is a cyclic ester. The lactones used to produce various embodiments of the polymers described herein can have carbon chain lengths between C2 and C20 atoms. In any of the aspects or embodiments described herein, the carbon atoms in the lactone backbone are independently substituted on each carbon with an R group, wherein R is selected from H, a C1-C6 aliphatic, an aromatic group (e.g., aryl or heteroaryl), a halogen, a nitrile, a nitro or ester functional group as shown in the structure below where n is an integer from 0 to 20.

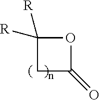

Specific examples of lactones suitable for use in the polyols or copolymers described and exemplified herein, include, for example, α-acetolactone, β-propiolactone, γ-butyrolactone, δ-valerolactone, ε-caprolactone, lactide, or glycolide. In any of the aspects or embodiments described herein, the lactone is selected from α-acetolactone, β-propiolactone, γ-butyrolactone, δ-valerolactone, ε-caprolactone, lactide, glycolide and a combination thereof. In any of the aspects or embodiments described herein, the lactone is ε-caprolactone.

Cyclic ethers suitable for use in the polyols or block copolymers described and exemplified herein, include, for example, substituted or unsubstituted (nonaromatic) heterocyclic compounds. The ethers with three atoms in the ring are commonly called as oxiranes, with four as oxetanes, five as tetrahydrofurans, and six as tetrahydropyrans. The cyclic ethers used to produce various embodiments of the polymers described herein can have carbon chain lengths between C2 and C20 atoms, wherein the ether carbon atoms are independently optionally substituted with an R group selected from H, C1-C6 aliphatic, aromatic, heteroaromatic, halogens, nitrile, nitro and ester functional groups as shown in the structure below where n is an integer between 0 to 20. Oxiranes are also known as epoxides. Some preferred cyclic ethers are exemplified by ethylene oxide, propylene oxide, 1,2-butylene oxide, 2,3-butylene oxide, tetrahydrofuran, methyltetrahydrofuran.

In certain embodiments, the description provides a polyol or copolymer comprising the reaction product of poly(farnesene) diol, e.g., poly(trans-β-farnesene) diol, and ε-caprolactone. Poly(farnesene) diols are produced from biobased monomers and such copolymerization allows incorporation of renewable material in high performance polyurethane materials.

In an aspect, the description provides a block copolymer of A-B-A type, having an average molecular weight of from about 1000 to about 10,000 g/mol (and including all subranges, such as, e.g., from about 1000 to about 9000 g/mol, from about 1000 to about 8000 g/mol, from about 1000 to about 7000 g/mol, from about 1000 to about 6000 g/mol, from about 1000 to about 5000 g/mol, from about 1000 to about 4000 g/mol, from about 1000 to about 3000 g/mol, from about 1000 to about 2000 g/mol, from about 2000 to about 10,000 g/mol, from about 3000 to about 10,000 g/mol, from about 4000 to about 10,000 g/mol, from about 5000 to about 10,000 g/mol, from about 6000 to about 10,000 g/mol, from about 7000 to about 10,000 g/mol, from about 8000 to about 10,000 g/mol, from about 9000 to about 10,000 g/mol, from about 1500 to about 5000 g/mol, from about 1500 to about 5000 g/mol, from about 2000 to about 5000 g/mol, from about 2500 to about 5000 g/mol, from about 3000 to about 5000 g/mol, from about 3500 to about 5000 g/mol, from about 2500 to about 3500 g/mol, or from about 2000 to about 3000 g/mol), said block copolymer being the reaction product of a poly(farnesene) diol and a cyclic lactone or cyclic ether. In any aspect or embodiment described herein, the poly(farnesene) diol is present in the range of from about 10 wt % to about 95 wt % or about 10 wt % to about 90 wt % (and including all subranges, such as, e.g., about 10-95 wt %, about 10-85 wt %, about 10-80 wt %, about 10-75 wt %, about 10-70 wt %, about 10-65 wt %, about 10-60 wt %, about 10-55 wt %, about 10-50 wt %, about 10-45 wt %, about 10-40 wt %, about 10-35 wt %, about 10-30 wt %, about 10-25 wt %, about 10-20 wt %, about 10-15 wt %, about 15-95 wt %, about 15-90 wt %, about 20-95 wt %, about 20-90 wt %, about 25-95 wt %, about 25-90 wt %, about 30-95 wt %, about 30-90 wt %, about 35-95 wt %, about 35-90 wt %, about 40-95 wt %, about 40-90 wt %, about 45-95 wt %, about 45-90 wt %, fro about 50-95 wt %, or about 50-90 wt %) of the total molecular weight of the block copolymer, and the cyclic lactone or cyclic ether is present in the range of from about 5 wt % to about 90 wt % or about 10 wt % to about 90 wt % (and including all subranges, such as, e.g., about 5-85 wt %, about 5-80 wt %, about 5-75 wt %, about 5-70 wt %, about 5-65 wt %, about 5-60 wt %, about 5-55 wt %, about 5-50 wt %, about 5-45 wt %, about 5-40 wt %, about 5-35 wt %, about 5-30 wt %, about 5-25 wt %, about 5-20 wt %, about 5-15 wt %, about 10-85 wt %, about 10-80 wt %, about 10-75 wt %, about 10-70 wt %, about 10-65 wt %, about 10-60 wt %, about 10-55 wt %, about 10-50 wt %, about 10-45 wt %, about 10-40 wt %, about 10-35 wt %, about 10-30 wt %, about 10-25 wt %, about 10-20 wt %, about 10-15 wt %, about 15-90 wt %, about 20-90 wt %, about 25-90 wt %, about 30-90 wt %, about 35-90 wt %, about 40-90 wt %, rom about 45-90 wt %, or about 50-90 wt %) of the total molecular weight of the block copolymer. In certain embodiments, the poly(farnesene) diol is poly(trans-β-farnesene) diol. In certain embodiments, the lactone or cyclic ether is ε-caprolactone. In certain embodiments, the poly(farnesene) diol is poly(trans-β-farnesene) diol, and the lactone or cyclic ether is ε-caprolactone.

In an aspect, the description provides a block copolymer of A-B-A type, having an average molecular weight of from about 1000 to about 10,000 g/mol (and including all subranges, such as, e.g., from about 1000 to about 9000 g/mol, from about 1000 to about 8000 g/mol, from about 1000 to about 7000 g/mol, from about 1000 to about 6000 g/mol, from about 1000 to about 5000 g/mol, from about 1000 to about 4000 g/mol, from about 1000 to about 3000 g/mol, from about 1000 to about 2000 g/mol, from about 2000 to about 10,000 g/mol, from about 3000 to about 10,000 g/mol, from about 4000 to about 10,000 g/mol, from about 5000 to about 10,000 g/mol, from about 6000 to about 10,000 g/mol, from about 7000 to about 10,000 g/mol, from about 8000 to about 10,000 g/mol, from about 9000 to about 10,000 g/mol, from about 1500 to about 5000 g/mol, from about 1500 to about 5000 g/mol, from about 2000 to about 5000 g/mol, from about 2500 to about 5000 g/mol, from about 3000 to about 5000 g/mol, from about 3500 to about 5000 g/mol, from about 2500 to about 3500 g/mol, or from about 2000 to about 3000 g/mol), said copolymer being the reaction product of a poly(trans-β-farnesene) diol and ε-caprolactone. In any aspect or embodiment described herein, the poly(trans-β-farnesene) diol is present in the range of from about 10 wt % to about 95 wt % or about 10 wt % to about 90 wt % (and including all subranges, such as, e.g., about 10-95 wt %, about 10-85 wt %, about 10-80 wt %, about 10-75 wt %, about 10-70 wt %, about 10-65 wt %, about 10-60 wt %, about 10-55 wt %, about 10-50 wt %, about 10-45 wt %, about 10-40 wt %, about 10-35 wt %, about 10-30 wt %, about 10-25 wt %, about 10-20 wt %, about 10-15 wt %, about 15-95 wt %, about 15-90 wt %, about 20-95 wt %, about 20-90 wt %, about 25-95 wt %, about 25-90 wt %, about 30-95 wt %, about 30-90 wt %, about 35-95 wt %, about 35-90 wt %, about 40-95 wt %, about 40-90 wt %, about 45-95 wt %, about 45-90 wt %, about 50-95 wt %, or about 50-90 wt %) of the total molecular weight of the block copolymer, and the ε-caprolactone is present in the range of from about 5 wt % to about 90 wt % or about 10 wt % to about 90 wt % (and including all subranges, such as, e.g., about 5-85 wt %, about 5-80 wt %, about 5-75 wt %, about 5-70 wt %, about 5-65 wt %, about 5-60 wt %, about 5-55 wt %, about 5-50 wt %, about 5-45 wt %, about 5-40 wt %, about 5-35 wt %, about 5-30 wt %, about 5-25 wt %, about 5-20 wt %, about 5-15 wt %, about 10-85 wt %, about 10-80 wt %, about 10-75 wt %, about 10-70 wt %, about 10-65 wt %, about 10-60 wt %, about 10-55 wt %, about 10-50 wt %, about 10-45 wt %, about 10-40 wt %, about 10-35 wt %, about 10-30 wt %, about 10-25 wt %, about 10-20 wt %, about 10-15 wt %, about 15-90 wt %, about 20-90 wt %, about 25-90 wt %, about 30-90 wt %, about 35-90 wt %, about 40-90 wt %, about 45-90 wt %, or about 50-90 wt %) of the total molecular weight of the block copolymer. In certain embodiments, the poly(farnesene) diol, e.g., the poly(trans-β-farnesene) diol, is present in an amount of from about 30 wt % to about 90 wt % of the total molecular weight of the block copolymer. In certain embodiments, the lactone, e.g., the ε-caprolactone, is present in an amount of from about 10 wt % to about 70 wt % of the total molecular weight of the block copolymer.

In another aspect, the disclosure provides a polyurethane or polyurethane-urea composition comprising the reaction product of:
a) at least one block copolymer of A-B-A type as described herein;
b) at least one diisocyanate; and
c) optionally a diol or diamine chain extender having a molecular weight from about 60 to 600 g/mol in an NCO:OH molar ratio of from 0.9:1 to 2:1.

In any of the aspects or embodiments of the polyurethane or polyurethane-urea composition, the at least one block copolymer is the reaction product of a poly(farnesene) diol and a cyclic lactone or a cyclic ether as described herein.

In any of the aspects or embodiments of the polyurethane or polyurethane-urea composition, the at least one block copolymer has an average molecular weight of from about 1000 to 10,000 g/mol (and including all subranges, such as, e.g., from about 1000 to about 9000 g/mol, from about 1000 to about 8000 g/mol, from about 1000 to about 7000 g/mol, from about 1000 to about 6000 g/mol, from about 1000 to about 5000 g/mol, from about 1000 to about 4000 g/mol, from about 1000 to about 3000 g/mol, from about 1000 to about 2000 g/mol, from about 2000 to about 10,000 g/mol, from about 3000 to about 10,000 g/mol, from about 4000 to about 10,000 g/mol, from about 5000 to about 10,000 g/mol, from about 6000 to about 10,000 g/mol, from about 7000 to about 10,000 g/mol, from about 8000 to about 10,000 g/mol, from about 9000 to about 10,000 g/mol, from about 1500 to about 5000 g/mol, from about 1500 to about 5000 g/mol, from about 2000 to about 5000 g/mol, from about 2500 to about 5000 g/mol, from about 3000 to about 5000 g/mol, from about 3500 to about 5000 g/mol, from about 2500 to about 3500 g/mol, or from about 2000 to about 3000 g/mol).

In any of the aspects or embodiments of the polyurethane or polyurethane-urea composition, the poly(farnesene) diol is present in the range of about 10 wt % to about 95 wt % or about 10 wt % to about 90 wt % (and including all subranges, such as, e.g., about 10-95 wt %, about 10-85 wt %, about 10-80 wt %, about 10-75 wt %, about 10-70 wt %, about 10-65 wt %, about 10-60 wt %, about 10-55 wt %, about 10-50 wt %, about 10-45 wt %, about 10-40 wt %, about 10-35 wt %, about 10-30 wt %, about 10-25 wt %, about 10-20 wt %, about 10-15 wt %, about 15-95 wt %, about 15-90 wt %, about 20-95 wt %, about 20-90 wt %, about 25-95 wt %, about 25-90 wt %, about 30-95 wt %, about 30-90 wt %, about 35-95 wt %, about 35-90 wt %, about 40-95 wt %, about 40-90 wt %, about 45-95 wt %, about 45-90 wt %, about 50-95 wt %, or about 50-90 wt %) of the total molecular weight of the at least one block copolymer and the cyclic lactone or cyclic ether is present in the range about 5-about 90 wt % or about 10-about 90 wt % (and including all subranges, such as, e.g., about 5-85 wt %, about 5-80 wt %, about 5-75 wt %, about 5-70 wt %, about 5-65 wt %, about 5-60 wt %, about 5-55 wt %, from about 5-50 wt %, about 5-45 wt %, about 5-40 wt %, about 5-35 wt %, about 5-30 wt %, about 5-25 wt %, about 5-20 wt %, about 5-15 wt %, about 10-85 wt %, about 10-80 wt %, about 10-75 wt %, about 10-70 wt %, about 10-65 wt %, about 10-60 wt %, about 10-55 wt %, about 10-50 wt %, about 10-45 wt %, about 10-40 wt %, about 10-35 wt %, about 10-30 wt %, about 10-25 wt %, about 10-20 wt %, about 10-15 wt %, about 15-90 wt %, about 20-90 wt %, about 25-90 wt %, about 30-90 wt %, about 35-90 wt %, about 40-90 wt %, about 45-90 wt %, or about 50-90 wt %) of the total molecular weight of the at least one block copolymer.

In any of the aspects or embodiments of the polyurethane or polyurethane-urea composition, the poly(farnesene) diol is poly(trans-β-farnesene) diol. In any of the aspects or embodiments of the polyurethane or polyurethane-urea composition, the lactone or cyclic ether is ε-caprolactone. In any of the aspects or embodiments of the polyurethane or polyurethane-urea composition, the poly(farnesene) diol is poly(trans-β-farnesene) diol, and the lactone or cyclic ether is ε-caprolactone.

In another aspect, the disclosure provides a polyurethane or polyurethane-urea composition comprising the reaction product of:
a) at least one block copolymer of A-B-A type having an average molecular weight of from about 1000 to 10,000 g/mol, wherein the at least one block copolymer is the reaction product of a poly(farnesene) diol, e.g., poly(trans-β-farnesene) diol, and a cyclic lactone or cyclic ether, e.g., ε-caprolactone, and wherein the poly(farnesene) diol is present in the range of from about 10 wt % to about 95 wt % or about 10 to about 90 wt % of the total molecular weight of the at least one block copolymer, and the cyclic lactone or cyclic ether is present in the range of about 5 wt % to about 90 wt % or about 10 to about 90 wt % of the total molecular weight of the at least one block copolymer;
b) at least one diisocyanate; and
c) optionally a diol or diamine chain extender having a molecular weight from about 60 to 600 g/mol in an NCO:OH molar ratio of from 0.9:1 to 2:1.

In any of the aspects or embodiments of the polyurethane or polyurethane-urea composition described herein, the poly(farnesene) diol, e.g., the poly(trans-β-farnesene) diol, is present in an amount of from about 30 wt % to about 90 wt % of the total molecular weight of the at least one block copolymer. In any of the aspects or embodiments of the polyurethane or polyurethane-urea composition described herein, the lactone, e.g., the ε-caprolactone, is present in an amount of from about 10 wt % to about 70 wt % of the total molecular weight of the at least one block copolymer.

In certain embodiments, the description provides a polyurethane or polyurethane-urea composition comprising the reaction product of:
a) at least one block copolymer of A-B-A type, having an average molecular weight of 1000 to 10,000 g/mol, wherein the at least one block copolymer is the reaction product of a poly(trans-β-farnesene) diol and ε-caprolactone, wherein the poly(trans-β-farnesene) diol of is present in the range of from about 10 wt % to about 70 wt % of the total molecular weight of the at least one block copolymer, and the ε-caprolactone is present in the range 30-90 wt % of the total molecular weight of the at least one block copolymer;
b) at least one diisocyanate; and
c) optionally a diol or diamine chain extender having a molecular weight from 60 to 600, in an NCO:OH molar ratio of from 0.9:1 to 2:1.

In any of the aspects or embodiments of the polyurethane or polyurethane-urea composition described herein, the NCO:OH molar ratio is in the range 0.9:1-1.7:1.

In any of the aspects or embodiments of the polyurethane or polyurethane-urea composition described herein, the NCO:OH molar ratio is in the range 0.95:1-1.5:1

In any of the aspects or embodiments of the polyurethane or polyurethane-urea composition described herein, the NCO:OH molar ratio is in the range 1:1-1.2:1.

The carbamate functionalized polymers are produced by reaction of isocyanate monomers. In any of the aspects or embodiments of the polyurethane or polyurethane-urea composition described herein, the isocyanate monomers comprise or are selected from the group consisting of tolylene diisocyanate (2,4- or 2,6-tolylene diisocyanate or a mixture thereof) (TDI), phenylenediisocyanate (m-, p-phenylenediisocyanate or a mixture thereof), 4,4′-diphenyl diisocyanate, 1,5-naphthalene diisocyanate (NDI), diphenylmethanediisocyanate (4,4′-, 2,4′- or 2,2′-diphenylmethanediisocyanate or a mixture thereof) (MDI), 4,4′-toluidine diisocyanate (TODI), and 4,4′-diphenylether diisocyanate, 1,2-xylylene diisocyanate (o-XDI), 1,3-xylylene diisocyanate (m-XDI), and 1,4-xylylene diisocyanate (p-XDI), 1,2-hydrogenated xylylene diisocyanate (o-H6XDI), 1,3-hydrogenated xylylene diisocyanate (m-H6XDI), and 1,4-hydrogenated xylylene diisocyanate (p-H6XDI), tetramethylxylylene diisocyanate (1,3- or 1,4-tetramethylxylylene diisocyanate or a mixture thereof) (TMXDI), and ω,ω′-diisocyanate-1,4-diethylbenzene, trimethylenediisocyanate, 1,2-propylenediisocyanate, butylenediisocyanate (tetramethylenediisocyanate, 1,2-butylenediisocyanate, 2,3-butylenediisocyanate, and 1,3-butylenediisocyanate), 1,5-pentamethylenediisocyanate (PDI), 1,6-hexamethylenediisocyanate (also called: hexamethylenediisocyanate) (HDI), 2,4,4- or 2,2,4-trimethylhexamethylenediisocyanate, and 2,6-diisocyanatemethyl caproate, 1,3-cyclopentane diisocyanate, 1,3-cyclopentene diisocyanate, cyclohexanediisocyanate (1,4-cyclohexanediisocyanate, 1,3-cyclohexanediisocyanate), 3-isocyanatomethyl-3,5,5-trimethylcyclohexyl isocyanate (also called: isophoron diisocyanate) (IPDI), methylenebis(cyclohexyl isocyanate) (also called: bis(isocyanatocyclohexyl)methane) (4,4′-, 2,4- or 2,2′-methylenebis(cyclohexyl isocyanate), their Trans,Trans-isomer, Trans,Cis-isomer, Cis,Cis-isomer, or a mixture thereof) (H12MDI), methylcyclohexanediisocyanate (methyl-2,4-cyclohexanediisocyanate, methyl-2,6-cyclohexanediisocyanate), norbornanediisocyanate (various isomer or a mixture thereof) (NBDI), 4,4′-diphenylmethanediisocyanate, isophorone diisocyanate, 1,6-hexamethylene diisocyanate, 1,5-napthylene diisocyanate, 4,4′-dicyclohexylmethane diisocyanate and combinations thereof.

In any of the aspects or embodiments of the polyurethane or polyurethane-urea composition described herein, the diisocyanate is selected from the group consisting of 4,4′-diphenylmethanediisocyanate, isophorone diisocyanate, 1,6-hexamethylene diisocyanate, 1,5-napthylene diisocyanate, 4,4′-dicyclohexylmethane diisocyanate.

In any of the aspects or embodiments of the polyurethane or polyurethane-urea composition described herein, the chain extenders are multifunctional molecules, for example, low molecular weight diols or diamines. In certain embodiments they react with diisocyanate functions to build polyurethane molecular weight and increase block length of a hard segment.

In any of the aspects or embodiments of the polyurethane or polyurethane-urea composition described herein, the diol chain extender comprises polyhydroxy compounds, for example lower aliphatic or short chain glycols having from 2-20, or 2-12, or 2-10 carbon atoms. In certain embodiments, the diol change extender comprises or is selected from the group consisting of diethylene glycol, propylene glycol, dipropylene glycol, 1,3-butanediol, 1,5-pentanediol, neopentylglycol, 1,4-cyclohexanedimethanol (CHDM), 2,2-bis[4-(2-hydroxyethoxy)phenyl]propane (HEPP), heptanediol, nonanediol, dodecanediol, ethylene glycol, 1,4-butanediol, 1,6-hexanediol, 1,4-di-(betahydroxyethyl)-hydroxyquinone, 1,4-di-(betahydroxyethyl)-bisphenol A, and combinations thereof.

In any of the aspects or embodiments of the polyurethane or polyurethane-urea composition described herein, the diol chain extender comprises or is selected from the group consisting of ethylene glycol, propylene glycol, 1,4-butanediol, 1,6-hexanediol, 1,4-di-(betahydroxyethyl)-hydroxyquinone, 1,4-cyclohexanedimethanol, 1,4-di-(betahydroxyethyl)-bisphenol A, and combinations thereof.

In any of the aspects or embodiments of the polyurethane or polyurethane-urea composition described herein, the chain extender comprises or is a diamine chain extender. In any of the aspects or embodiments of the polyurethane or polyurethane-urea composition described herein, the diamine chain extender comprises or is selected from a group of 4,4′-diaminodiphenylmethane, 3,3′-dichloro-4,4′-diaminodiphenylmethane, 1,4-diaminobenzene, 3,3′-dimethoxy-4,4-diamino biphenyl, 3,3′-dimethyl-4,4-diamino biphenyl, 4,4′-diamino biphenyl, 3,3′-dichloro-4,4′-diamino biphenyl, and combinations thereof.

In any of the aspects or embodiments of the polyurethane or polyurethane-urea composition described herein, the composition is used for processing as a thermoplastic polyurethane, hot cast elastomer, cold cast elastomer, microcellular polyurethane foam, polyurethane dispersion in aqueous or organic media, polyurethane adhesive, 1- or 2-component polyurethane coating or polyurethane sealant.

In any of the aspects or embodiments of the polyurethane or polyurethane-urea composition described herein, the composition is processed as a thermoplastic polyurethane, hot cast elastomer or elastomeric foam.

In any of the aspects or embodiments of the polyurethane or polyurethane-urea composition described herein, the composition is processed as a thermoplastic polyurethane or hot cast elastomer.

In various embodiments, compositions and methods are described to produce high performing commercially available elastomer materials by employing copolymers of a poly(farnesene) diol and ε-caprolactone as the polyol component. Poly(farnesene) diols are produced from biobased monomers and such copolymerization allows incorporation of renewable material in high performance polyurethane materials.

In any of the aspects or embodiments described herein, the polyols or copolymers as described herein can be used to produce polyurethane materials of less than 75 Shore A hardness that not only retains its hardness over time but can be produced with industrially viable cycle times.

Shore values are measured by a Shore durometer, a device for measuring the hardness of a material, typically of polymers, elastomers, and rubbers. The scale ranges from 0-100. Higher numbers on the scale indicate a greater resistance to indentation and thus harder materials. Lower numbers indicate less resistance and softer materials.

In any of the aspects or embodiments described herein, the polyols or copolymers as described herein, can be used to produce polyurethane materials of less than 65 Shore.

In any of the aspects or embodiments described herein, the polyols or copolymers as described herein, can be used to produce polyurethane materials of less than 50 Shore.

In any of the aspects or embodiments described herein, the polyols or copolymers as described herein, can be used to produce polyurethane materials of less than 45 Shore.

In any of the aspects or embodiments described herein, the polyols or copolymers as described herein, can be used to produce polyurethane materials of less than 35 Shore.

In any of the aspects or embodiments described herein, the polyols or copolymers as described herein, can be used to produce polyurethane materials of less than 25 Shore.

The entire disclosure of U.S. Pat. No. 3,784,520A is incorporated by reference herein for chemicals and methods to prepare co-polylactone-farnesene diol polyester polymers.

In another aspect, the description provides a co-polyamide-polyester composition, produced as the reaction product of:
a) at least one block copolymer of A-B-A type as described herein; and
b) at least one polyamide of an oligomer of structure D-(E-D)x or Fy-D-Fz where D is an alpha-omega diacid, E is a alpha—omega diamine and F is a lactam or/and alpha amine omega acid, and x, y, and z are an integer equal to or greater than 1.

In any aspect or embodiment of the co-polyamide-polyester composition, the at least one block copolymer of A-B-A type has an average molecular weight of from about 1000 g/mol to about 10,000 g/mol, wherein the copolymer is the reaction product of a poly(farnesene) diol and a cyclic lactone or cyclic ether, and wherein the poly(farnesene) diol is present in the range of from about 10 wt % to about 90 wt % of the total molecular weight of the at least one block copolymer, and the cyclic lactone or cyclic ether is present in the range of from about 10 wt % to about 90 wt % of the total molecular weight of the at least one block copolymer.

In any aspect or embodiment of the co-polyamide-polyester composition, D, E and F are independently selected from a C2-C12 aliphatic or aromatic group.

In any aspect or embodiment of the co-polyamide-polyester composition, the co-polyamide-polyester composition is of the structure Fy-D-Fz, wherein F is a C11, D is a C12 and y and z are an integer between 1 and 5.

In another aspect, the description provides a co-polyester composition, produced as the reaction product of:
a) at least one block copolymer of A-B-A type as described herein;
b) at least one diacid; and
c) at least one short chain diol, wherein the molecular weight of the short chain diol is <250 g/mol.

In any aspect or embodiment of the co-polyester composition, the composition has an average molecular weight of from about 1000 g/mol to about 10,000 g/mol, wherein the copolymer is the reaction product of a poly(farnesene) diol and a cyclic lactone or cyclic ether, and wherein the poly(farnesene) diol is present in the range of from about 10 wt % to about 90 wt % of the total molecular weight of the at least one block copolymer, and the cyclic lactone or cyclic ether is present in the range of from about 10 wt % to about 90 wt % of the total molecular weight of the at least one block copolymer.

In any aspect or embodiment of the co-polyester composition, the block copolymer is between about 90 wt % and about 25 wt % of the co-polyester composition.

In any aspect or embodiment of the co-polyester composition, the short chain diol is less than 25 wt % of the co-polyester composition.

In any aspect or embodiment of the co-polyester composition, the diol is 1,4-butane diol.

### EXAMPLES

Materials

Polycaprolactone polyols were produced by subjecting ε-caprolactone to reaction (ring-opening polymerization) with the trans-β-fanesene diol Krasol® F3000 (Total Cray Valley, Exton, Pennsylvania) at molar ratios yielding polycaprolactone according to Table 1.

TABLE 1

| Exemplary Polyol formulations | Ex. 1 | Ex. 2 | Ex. 3 | Ex. 4 |
|---|---|---|---|---|
| Caprolactone content (wt %) | 14 | 29 | 40 | 48 |
| Molecular weight of copolymer | 3200 | 3900 | 4500 | 5300 |
| (g/mol) | | | | |
| Hydroxyl value (mg KOH/g) | 35.2 | 28.9 | 24.5 | 21.3 |
| Viscosity (mPa · s) | 110.9 | 153.4 | 248.7 | 380 |

The reactions were performed at 180° C. in the presence of stannous octoate (DABCO T9) as catalyst and monitored by GC determination of residual ε-caprolactone. The reactions were terminated when the amount of residual ε-caprolactone was less than 0.5%.

Polyols used as comparative materials are CAPA® 2201A (Ingevity, United Kingdom), a typical polyol used in high performing polyurethane applications, and Krasol® F3000 (Total Cray Valley, France), a polyfarnesene diol made using 100% renewable raw materials.

Examples of the compositions and methods described and comparative examples were prepared via a hot cast production process (Examples 1-6) and a thermoplastic polyurethane (TPU) production process (Examples 7-23).

### Examples 1-6

To prepare hot cast polyurethane elastomer materials according to Table 2, the requisite polyol was first added dropwise to molten 4,4′-diphenylmethanediisocyanate and reacted at 80° C. for 2 h. This yielded a polyurethane prepolymer of 3.98% NCO. To this, 1,4-butanediol was added, according to 97% stoichiometry or 103 isocyanate index, and the mixture homogenized using a vortex mixer for 2 min. The reaction mixture was then poured onto a coated metal plate that had been conditioned at 120° C. for 1 hour. The cast sheets were then placed in an oven at 120° C. for 16 hours before being de-moulded and cooled to 23° C.

TABLE 2

| | | Polyol Renewable | | |
|---|---|---|---|---|
| | | Content (bio- | Parts | Parts |
| Example | | based farnesene) | Polyol | isocyanate |
| | Exemplary | | | |
| | Polyols | | | |
| 1 | Ex. 1 | 86 | 100 | 27.7 |
| 2 | Ex. 2 | 71 | 100 | 27.7 |
| 3 | Ex. 3 | 60 | 100 | 27.7 |
| 4 | Ex. 4 | 52 | 100 | 27.7 |
| | Comparative | | | |
| | Polyols | | | |
| 5* | Krasol ® F3000 | 100 | 100 | 27.7 |
| 6* | CAPA ® 2201A | 0 | 100 | 27.7 |

*Comparative examples.

The mechanical properties of the polyurethane material were determined according to ISO 37 (Type 2) (Ultimate Tensile Strength, Elongation) and ASTM D 624 Type C (Tear Strength).

Tensile tests were conducted according to ISO 37 using Type 2 specimens (dumbbell-shaped test pieces of 2.0 mm+/−0.2 mm in thickness and a test length of 20 mm+/−0.5 mm). Test pieces were cut from 2.0 mm polyurethane sheets using a die-cutter and then conditioned at 23° C./50% relative humidity for a period of 7 days prior to testing. Test pieces were subjected to deformation in tensile mode at a rate of traverse of 200 mm/min using a ZwickRoell Proline Z010 tensometer equipped with pincer grips and a 10 kN load cell until the test piece is broken. Ultimate tensile strength is defined as the stress recorded at breakage of the sample, in megapascals (MPa or N/mm²). Ultimate elongation is defined as the percentage increase in test length at break. The elastic modulus is defined as the average stress/strain in the first 0.25% elongation of the material and is a measure of the material's resistance to deformation.

Tear strength tests were conducted according to ASTM D 624 using Die C/right angle specimens (an un-nicked test piece with a 90° right angle on one side and with tab ends) of 2.0 mm+/−0.2 mm thickness. Test pieces were cut from 2.0 mm polyurethane sheets using a die-cutter and then conditioned at 23° C./50% relative humidity for a period of 7 days prior to testing. Test pieces were subjected to deformation in tensile mode at a rate of traverse of 500 mm/min using a ZwickRoell Proline Z010 tensometer equipped with pincer grips and a 10 kN load cell until the test piece is completely torn. Tear strength is defined as the force required to cause a rupture of the test piece, divided by the thickness of the test piece.

In each of the exemplary polyols (i.e., “Ex. 1-4”) a significant improvement in the ultimate tensile strength, ultimate elongation, tear strength and modulus of elasticity was shown compared to the reference polyol with 100% renewable content (Comparative Example 5). Surprisingly it was found that the performance of a premium polyol such as CAPA® 2201A could be achieved whilst maintaining more than 50% renewable content (e.g., bio-based farnesene) in the polyol.

TABLE 3

| | | | Ultimate | | | |
|---|---|---|---|---|---|---|
| | | Polyol | Tensile | Ultimate | Tear | Modulus |
| | Exemplary | Renewable | Strength | Elongation | Strength | of |
| Example | Polyols | Content | (MPa) | (%) | (kN/m) | Elasticity |
| 1 | Ex. 1 | 86 | 5.3 | 282 | 14.6 | 5.7 |
| 2 | Ex. 2 | 71 | 7.2 | 436 | 32.6 | 9.5 |
| 3 | Ex. 3 | 60 | 10.2 | 619 | 47.5 | 12.2 |
| 4 | Ex. 4 | 52 | 15.1 | 822 | 52.4 | 19.6 |
| | Comparative | | | | | |
| | Polyols | | | | | |
| 5* | Krasol ® | 100 | 3.2 | 222 | 14.5 | 3.2 |
| | F3000 | | | | | |
| 6* | CAPA ® | 0 | 9.6 | 970 | 53.6 | 9.3 |
| | 2201A | | | | | |

*Comparative example not according to the invention

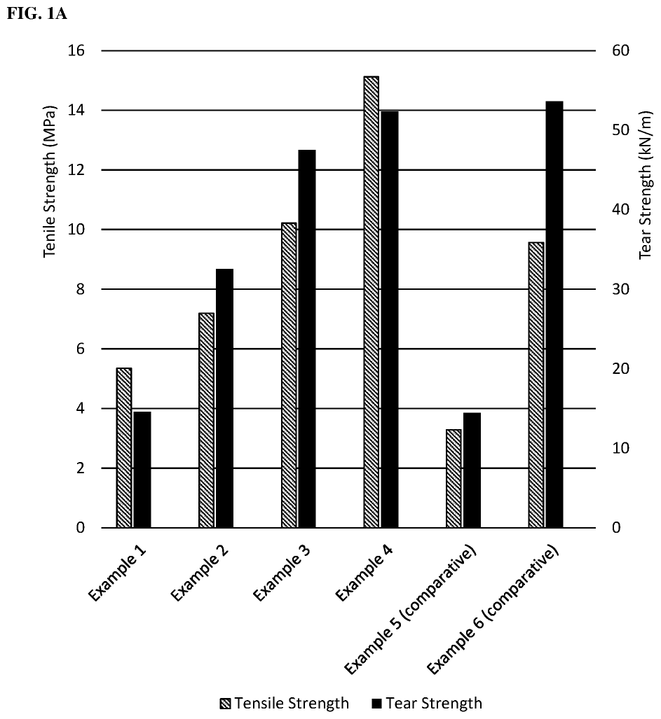

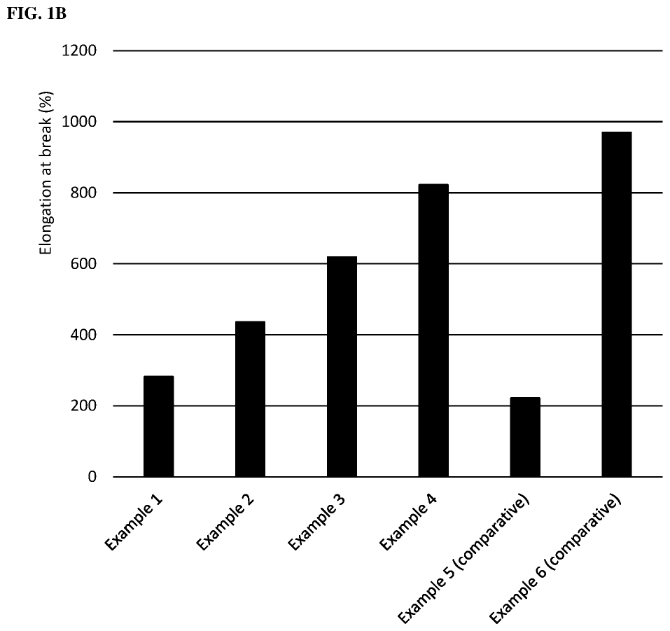

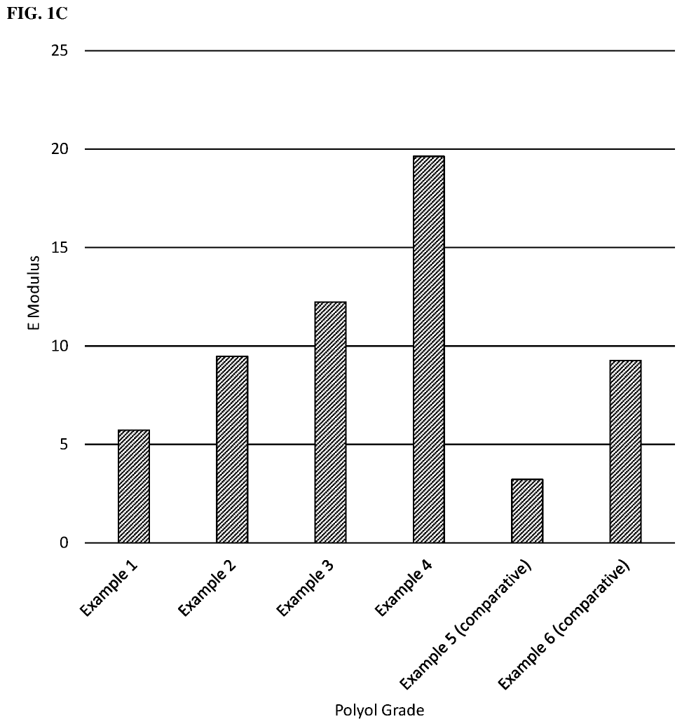

FIGS. 1A, 1B and 1C illustrate further the difference in mechanical properties in accordance with the compositions as described herein as compared to currently available materials. FIG. 1A, shows a comparison, tensile strength (left-hand axis) and tear strength (right-hand axis). FIG. 1B, shows a comparison, ultimate elongation. FIG. 1C, shows a comparison, modulus of elasticity.

To prepare thermoplastic polyurethane elastomer materials according to Table 4, a one-shot bulk polymerization was performed. The polyol, extender (1,4-butane), antioxidant (BHT derivative), and diisocyanate are weighed into the reactor. No catalyst was used when using aromatic diisocyanates. When using aliphatic isocyanates, a catalyst based on Sn(IV) was employed. The weights of the polyol, extender, and diisocyanate to have a stoichiometry (NCO to OH ratio) 1.02. The reaction is mixed until a 5° C. increase in temperature is achieved. The reacting mixture is transferred into a tray and cured in an oven for 3 hours minimum. The cooled slabs were sized reduce and melt processed into test specimen.

TABLE 4

| | | | | | Parts |
|---|---|---|---|---|---|
| | | Polyol | | Di- | isocyanate |
| | | Renewable | Parts | isocyanate | and short |
| Example | | Content | Polyol | type * | chain diol |
| | Exemplary | | | | |
| | Polyol | | | | |
| 7 | 1 | 86 | 75 | AL | 25 |
| 8 | 2 | 71 | 75 | AL | 25 |
| 9 | 3 | 60 | 75 | AL | 25 |
| 10 | 4 | 52 | 75 | AL | 25 |
| 11 | 4 | 52 | 92 | AL | 8 |
| 12 | 4 | 52 | 90 | AL | 10 |
| 13 | 4 | 52 | 85 | AL | 15 |
| 14 | 4 | 52 | 50 | AL | 50 |
| 15 | 4 | 52 | 25 | AL | 75 |
| 16 | 4 | 52 | 92 | AR | 8 |
| 17 | 4 | 52 | 90 | AR | 10 |
| 18 | 4 | 52 | 80 | AR | 20 |
| 19 | 4 | 52 | 70 | AR | 30 |
| 20 | 4 | 52 | 50 | AR | 50 |
| 21 | 4 | 52 | 25 | AR | 75 |
| | Comparative | | | | |
| | Polyol | | | | |
| 22** | Krasol ® | 100 | 70 | AL | 30 |
| | F3000 | | | | |
| 23** | CAPA ® | 0 | 55 | AL | 45 |
| | 2201A | | | | |

* AL is H12MDI, AR is MDI
**Comparative example.

TABLE 5

| | | | Ultimate | | 100% | |
|---|---|---|---|---|---|---|
| | | Polyol | Tensile | Ultimate | Tensile | |
| | Exemplary | Renewable | Strength | Elongation | Modulus | Shore A |
| Example | Polyol | Content | (MPa) | (%) | (MPa) | Durometer |
| 7 | 1 | 86 | 10.3 | 551 | 4.3 | 60A |
| 8 | 2 | 71 | 12.5 | 657 | 4.3 | 63A |
| 9 | 3 | 60 | 17.7 | 591 | 4.9 | 61A |
| 10 | 4 | 52 | 16.2 | 840 | 4.5 | 68A |
| 11 | 4 | 52 | Not tested | Not tested | Not tested | 65A |
| 12 | 4 | 52 | 13.4 | 605 | 1.7 | 52A |
| 13 | 4 | 52 | 12.3 | 804 | 1.3 | 53A |
| 14 | 4 | 52 | 25.2 | 389 | 12.4 | 42D |
| 15 | 4 | 52 | 40.7 | 158 | 34.8 | 67D |
| 16 | 4 | 52 | 15.7 | 797 | 1.3 | 48A |
| 17 | 4 | 52 | 12.6 | 717 | | 52A |
| 18 | 4 | 52 | 17.5 | 832 | | 68A |
| 19 | 4 | 52 | 23.6 | 639 | | 82A |
| 20 | 4 | 52 | 29.1 | 328 | 15.1 | 48D |
| 21 | 4 | 52 | 38.6 | 197 | 32.9 | 65D |
| | Comparative | | | | | |
| | Polyol | | | | | |
| 22* | Krasol ® F3000 | 100 | 10.0 | 336 | | 64A |
| 23* | CAPA ® 2201A | 0 | 55 | 500 | 4 | 85A |

*Comparative example.

The data presented in Table 5 further support the inventions of the present disclosure.

The contents of all references, patents, pending patent applications and published patents, cited throughout this application are hereby expressly incorporated by reference.

Those skilled in the art will recognize or be able to ascertain using no more than routine experimentation, many equivalents to the specific embodiments of the invention described herein. Such equivalents are intended to be encompassed by the following claims. It is understood that the detailed examples and embodiments described herein are given by way of example for illustrative purposes only and are in no way considered to be limiting to the invention. Various modifications or changes in light thereof will be suggested to persons skilled in the art and are included within the spirit and purview of this application and are considered within the scope of the appended claims. For example, the relative quantities of the ingredients may be varied to optimize the desired effects, additional ingredients may be added, and/or similar ingredients may be substituted for one or more of the ingredients described. Additional advantageous features and functionalities associated with the systems, methods, and processes of the present invention will be apparent from the appended claims. Moreover, those skilled in the art will recognize, or be able to ascertain using no more than routine experimentation, many equivalents to the specific embodiments of the invention described herein. Such equivalents are intended to be encompassed by the following claims.

What is claimed is:

1. A block copolymer of A-B-A type comprising the reaction product of a poly(farnesene) diol and a cyclic lactone or cyclic ether, wherein the poly(farnesene) diol is present in the range of from about 10 wt % to about 95 wt % (e.g., about 10 wt % to about 90 wt %) of the total molecular weight of the copolymer, and wherein the cyclic lactone or cyclic ether is present in the range of from about 5 wt % to about 90 wt % (e.g., about 10 wt % to about 90 wt %) of the total molecular weight of the copolymer, the copolymer having an average molecular weight of from about 1000 g/mol to about 10,000 g/mol.

2. The copolymer of claim 1, wherein the poly(farnesene) diol is a polymer comprising at least one monomer selected from (E,E)-α-farnesene, (Z,E)-α-farnesene, (Z,Z)-α-farnesene, cis-β-farnesene, trans-β-farnesene, a hydrogenated derivative thereof, and combinations thereof.

3. The copolymer of claim 1, wherein the cyclic lactone is at least one of α-acetolactone, β-propiolactone, γ-butyrolactone, δ-valerolactone, ε-caprolactone, lactide, glycolide or a combination thereof.

4. The copolymer of claim 3, wherein the cyclic lactone is ε-caprolactone.

5. The copolymer of claim 1, wherein the cyclic ether is at least one of ethylene oxide, propylene oxide, 1,2-butylene oxide, 2,3-butylene oxide, tetrahydrofuran, methyltetrahydrofuran or a combination thereof.

6. The copolymer of claim 5, wherein poly(farnesene) diol is present in the range of from about 10 wt % to about 60 wt % of the total molecular weight of the block copolymer.

7. The copolymer of claim 1, wherein poly(farnesene) diol is present in the range of from about 10 wt % to about 60 wt % of the total molecular weight of the block copolymer.

8. A polymeric composition comprising a reaction product of the copolymer of claim 1 and at least one of a diacid, a diisocyanate, urea, dinitrile or a combination thereof, thereby forming a polyester, polyurethane, polyurethane-urea, polyamide or polyamide material.

9. A polymeric composition comprising as the reaction product of:
a) at least one block copolymer of A-B-A type, having an average molecular weight of 1000 to 10,000 g/mol, the at least one block copolymer being the reaction product of a poly(farnesene) diol and a cyclic lactone or cyclic ether, wherein the poly(farnesene) diol is present in the range of from about 10 wt % to about 95 wt % (e.g., about 10 wt % to about 90 wt %) of the total molecular weight of the at least one block copolymer, and the cyclic lactone or cyclic ether is present in the range of from about 5 wt % to about 95 wt % (e.g., about 10 wt % to about 90 wt %) of the total molecular weight of the at least one block copolymer;
b) at least one diisocyanate; and
c) optionally a diol or diamine chain extender having a molecular weight of from about 60 g/mol to about 600 g/mol, with an NCO:OH molar ratio of from about 0.9:1 to about 2:1.

10. The polymeric composition of claim 9, wherein the poly(farnesene) diol is a polymer comprising at least one monomer selected from (E,E)-α-farnesene, (Z,E)-α-farnesene, (Z,Z)-α-farnesene, cis-β-farnesene, trans-β-farnesene, a hydrogenated derivative thereof, and combinations thereof.

11. The polymeric composition of claim 9, wherein the cyclic lactone is at least one of α-acetolactone, β-propiolactone, γ-butyrolactone, δ-valerolactone, ε-caprolactone, lactide, glycolide or a combination thereof.

12. The polymeric composition of claim 11, wherein the cyclic lactone is ε-caprolactone.

13. The polymeric composition of claim 9, wherein the cyclic ether is at least one of ethylene oxide, propylene oxide, 1,2-butylene oxide, 2,3-butylene oxide, tetrahydrofuran, methyltetrahydrofuran or a combination thereof.

14. The polymeric composition of claim 13, wherein poly(farnesene) diol is present in the range of from about 10 wt % to about 60 wt % of the total molecular weight of the at least one block copolymer.

15. The polymeric composition of claim 9, wherein poly(farnesene) diol is present in the range of from about 10 wt % to about 60 wt % of the total molecular weight of the at least one block copolymer.

16. The polymeric composition of claim 9, wherein the at least one block copolymer comprises in the range of from about 25 wt % to about 95 wt % of the polymer composition, and wherein the polymer composition is a polyurethane or polyurethane-urea.

17. The polymeric composition of claim 9, wherein the polymeric composition has a Shore Hardness of between about 25 Shore A and about 60 Shore D.

18. The polymeric composition of claim 9, wherein the diisocyanate is selected from a group consisting of 4,4′-diphenylmethanediisocyanate, isophorone diisocyanate, 1,6-hexamethylene diisocyanate, 1,5-napthylene diisocyanate, 4,4′-dicyclohexylmethane diisocyanate, and combinations thereof.

19. The polymeric composition of claim 9, wherein the diol chain extender is selected from a group consisting of ethylene glycol, 1,4-butanediol, 1,6-hexanediol, 1,4-di-(betahydroxyethyl)-hydroxyquinone, 1,4-cyclohexanedimethanol, 1,4-di-(betahydroxyethyl)-bisphenol A, and combinations thereof.

20. The polymeric composition of claim 9, wherein the diamine chain extender is selected from a group consisting of 4,4′-diaminodiphenylmethane, 3,3′-dichloro-4,4′-diaminodiphenylmethane, 1,4-diaminobenzene, 3,3′-dimethoxy-4,4-diamino biphenyl, 3,3′-dimethyl-4,4-diamino biphenyl, 4,4′-diamino biphenyl, 3,3′-dichloro-4,4′-diamino biphenyl, and combinations thereof.

21. The polymeric composition of claim 9, wherein the polymeric composition is at least one of a thermoplastic polyurethane, hot cast elastomer, cold cast elastomer, microcellular polyurethane foam, polyurethane dispersion in aqueous or organic media, polyurethane adhesive, 1- or 2-component polyurethane coating, additive manufacturing material or polyurethane sealant.

22. A co-polyamide-polyester composition, produced as the reaction product of:
a) at least one block copolymer of A-B-A type having an average molecular weight of from about 1000 g/mol to about 10,000 g/mol, wherein the copolymer is the reaction product of a poly(farnesene) diol and a cyclic lactone or cyclic ether, and wherein the poly(farnesene) diol is present in the range of from about 10 wt % to about 95 wt % (e.g., about 10 wt % to about 90 wt %) of the total molecular weight of the at least one block copolymer, and the cyclic lactone or cyclic ether is present in the range of from about 5 wt % to about 90 wt % (e.g., about 10 wt % to about 90 wt %) of the total molecular weight of the at least one block copolymer; and
b) at least one polyamide of an oligomer of structure D-(E-D)x or Fy-D-Fz where D is an alpha—omega diacid, E is a alpha—omega diamine and F is a lactam or/and alpha amine omega acid, and x, y, and z are an integer equal to or greater than 1.

23. The co-polyamide-polyester composition of claim 22, wherein D, E and F are independently selected from a C2-C12 aliphatic or aromatic group.

24. The co-polyamide-polyester composition of claim 23, wherein the co-polyamide-polyester composition is of the structure Fy-D-Fz, wherein F is a C11, D is a C12 and y and z are an integer between 1 and 5.

25. A co-polyester composition, produced as the reaction product of:
a) at least one block copolymer of A-B-A type, having an average molecular weight of from about 1000 g/mol to about 10,000 g/mol, wherein the copolymer is the reaction product of a poly(farnesene) diol and a cyclic lactone or cyclic ether, and wherein the poly(farnesene) diol is present in the range of from about 10 wt % to about 95 wt % (e.g., about 10 wt % to about 90 wt %) of the total molecular weight of the at least one block copolymer, and the cyclic lactone or cyclic ether is present in the range of from about 5 wt % to about 90 wt % (e.g., about 10 wt % to about 90 wt %) of the total molecular weight of the at least one block copolymer;
b) at least one diacid; and
c) at least one short chain diol, wherein the molecular weight of the short chain diol is <250 g/mol.

26. The co-polyester composition of claim 25, wherein the block polymer is between about 90 wt % and about 25 wt % of the co-polyester composition.

27. The co-polyester composition of claim 25, wherein the short chain diol is less than 25 wt % of the co-polyester composition.

28. The co-polyester composition of claim 25, wherein the diacid is terephthalic acid.

29. The co-polyester composition of claim 25, the diol is 1,4-butane diol.
